(19) United States
(12) Patent Application Publication
(10) Pub. No.: US 2026/0249609 A1
(43) Pub. Date: Aug. 27, 2026

(54) INKJET PRINTHEAD

(71) Applicant: ENJET CO. LTD., Suwon-si (KR)

(72) Inventors: Do Young Byun, Seoul (KR); Byungjik Lim, Suwon-si (KR); Shaheer Mohiuddin Khalil, Suwon-si (KR); Baek Hoon Seong, Hwaseong-si (KR); Jaewoo Joung, Seongnam-si (KR); Jaeyong Choi, Suwon-si (KR)

(21) Appl. No.: 19/159,197

(22) PCT Filed: Jun. 21, 2024
(86) PCT No.: PCT/KR2024/008633

§ 371 Date: Aug. 22, 2025

(30) Foreign Application Priority Data
Jun. 23, 2023 (KR) 10-2023-0080865

(51) Int. Cl. B41J 2/06; B41J 2/045; B41J 2/14

(52) U.S. Cl. CPC B41J 2/06; B41J 2/0455; B41J 2/04576; B41J 2/1433; B41J 2002/14411; B41J 2002/14475; B41J 2002/14491

(57) ABSTRACT

Disclosed is an inkjet printhead. The inkjet printhead with a plurality of nozzles to eject a liquid solution by an electrohydrodynamic method includes a printhead unit comprising a plurality of nozzles, a plurality of first electrodes formed inside the nozzle for each of the plurality of nozzles; a second electrode formed inside the printhead unit and receiving a voltage for ejecting the liquid solution by the electrohydrodynamic method, a voltage controller configured to apply a constant voltage to the second electrode, and a controller configured to control the first electrode to be grounded or be electrically disconnected from the ground, for each of the plurality of nozzles. The controller controls each nozzle individually to eject the liquid solution in such a manner that the liquid solution is not ejected upon the first electrode being grounded but ejected upon the first electrode being electrically disconnected from the ground.

### CROSS-REFERENCE TO RELATED APPLICATIONS

This Application is a Section 371 National Stage Application of International Application No. PCT/KR2024/008633, filed Jun. 21, 2024 and published as WO 2024/262996 A1 on Dec. 26, 2024, and claims priority to Korean Application No. 10-2023-0080865, filed Jun. 23, 2023.

### FIELD

The disclosure relates to an inkjet printhead, and more particularly to an inkjet printhead that has multiple nozzles and ejects a liquid solution by an electrohydrodynamic method.

### BACKGROUND

In general, an inkjet printhead refers to a device that prints an image with predetermined colors on a surface of a printing medium by ejecting fine droplets of ink to a desired position on the printing medium. The applications of the inkjet printhead have recently expanded to various fields such as a liquid crystal display (LCD), an organic light emitting device (OLED) and similar flat panel display fields; electronic (E)-paper and similar flexible display fields; metal wiring and similar printed electronics fields; bio fields; and so on.

Drop-on-demand (DOD) inkjet printhead is classified according to the ejecting method. A piezoelectric inkjet printhead ejects ink by pressure waves based on transformation of a piezoelectric body, and an electrohydrodynamic inkjet printhead ejects ink by electrostatic force.

In the piezoelectric inkjet printhead, a piezoelectric body vibrates a membrane to apply pressure to a chamber containing ink, thereby ejecting the ink. In general, droplets are ejected when pressure is high enough to overcome the surface tension and viscosity of the ink on the surface of a and additionally applied pressure is required to be high enough to accelerate the ejected droplets to a speed at which these droplets can be accurately settled on a printing medium. To discharge a droplet of several picoliters or less, the piezoelectric inkjet printhead needs to reduce transformation energy in a pressure chamber. When the transformation energy in the pressure chamber is reduced, ejecting energy per unit volume of the ejected droplets is also reduced, and therefore an ejecting speed of the droplets is decreased. However, when the ejecting speed of the droplets is decreased, a problem arises in that the droplets are not accurately ejected to desired positions.

The piezoelectric inkjet printhead is advantageous in that it is easy to control a printing job, and there are no restrictions on the types of ink because the ejecting energy is based on mechanical transformation. However, the piezoelectric inkjet printhead has difficulty in ejecting ultrafine droplets of several picoliters or less, and has a limitation in that the discharge of only ink having a viscosity of about 10 cPs is possible but the discharge of ink having a high viscosity is not possible. Further, it is difficult to discharge big droplets of 80 picoliters or more due to the limitations on the ejecting energy. In particular, the piezoelectric inkjet printhead has a limitation even though volume uniformity of ejected droplets between a plurality of nozzles is very important for applications to the processes of the printed electronics such as a display, etc. unlike the existing graphic printing.

On the other hand, the electrohydrodynamic inkjet printhead provides the ejecting energy by applying electrostatic force to a liquid surface of ink formed at the end of a nozzle, and is therefore advantageous in that the discharge of ultrafine droplets of not more than several picoliters or femtoliters is possible and the discharge of ink droplets having a high viscosity of about 1,000 cPs is possible. Besides, it is also possible to discharge big droplets of 80 picoliters or more. The electrohydrodynamic inkjet printhead is advantageous for precise printing because a driving method is simple and the directionality of ejected ink droplets is excellent due to control based on distribution of an electric field formed on the nozzle.

However, when the multiple nozzles are formed in the electrohydrodynamic inkjet printhead, the size of droplets ejected through the plurality of nozzles is not uniform due to electric field interference between neighboring nozzles, thereby causing a problem of poor print quality.

Further, when the multiple nozzles are formed, there is difficulty in controlling each nozzle individually to eject a liquid solution.

### Document of Related Art

### Patent Document

Korean Patent No. 1310759

### SUMMARY

Accordingly, disclosed embodiments have been conceived to solve the foregoing problems, and an aspect of the disclosure is to provide an inkjet printhead that has a plurality of nozzles and ejects a liquid solution by an electrohydrodynamic method, in which a first nozzle is disposed for each nozzle, and the first electrode is individually controlled to be grounded or be electrically disconnected from the ground for each nozzle in a state that a constant voltage is applied to a second electrode formed as a common electrode or an individual electrode for each nozzle or a constant voltage is applied to supplied ink, so that the liquid solution can be discharged by an induced voltage generated in the first electrode only when the first electrode is electrically disconnected from the ground, thereby individually controlling the liquid solution to be ejected for each nozzle.

The problems to be solved by the disclosure are not limited to those mentioned above, and other unmentioned problems will become apparent to a person skilled in the art by the following descriptions.

In accordance with an embodiment of the disclosure, there is provided an inkjet printhead with a plurality of nozzles to eject a liquid solution by an electrohydrodynamic method, the inkjet printhead including: a printhead unit comprising a plurality of nozzles; a plurality of first electrodes formed inside the nozzle for each of the plurality of nozzles; a second electrode formed inside the printhead unit and receiving a voltage for ejecting the liquid solution by the electrohydrodynamic method; a voltage controller configured to apply a constant voltage to the second electrode; and a controller configured to control the first electrode to be grounded or be electrically disconnected from the ground, for each of the plurality of nozzles, wherein the controller controls each nozzle individually to eject the liquid solution in such a manner that the liquid solution is not ejected upon the first electrode being grounded but ejected by generating an induced voltage in the first electrode upon the first electrode being electrically disconnected from the ground.

Here, the second electrode may be formed as a common electrode for the plurality of nozzles.

Here, the printhead unit may include: a first nozzle layer comprises the plurality of nozzles, and a first chamber formed to store ink supplied for each of the plurality of nozzles; and a second nozzle layer formed above the first nozzle layer, comprising a second chamber communicating with the first chamber for each of the plurality of nozzles, and forming the second electrode.

Here, the second chamber may include a nozzle hole at a bottom thereof to eject the liquid solution.

Here, the first electrode may be formed on an inner surface of the first chamber, and the second electrode may be formed on an inner surface of the second chamber.

Here, the inkjet printhead may further include a third electrode disposed between and spaced apart from the first electrodes formed in the nozzles, or disposed between and spaced apart from the second electrodes formed in the nozzles, and grounded to prevent electric field interference between the nozzles.

Here, the inkjet printhead may further include a third electrode disposed between and spaced apart from the first electrodes formed in the nozzles, or disposed between and spaced apart from the second electrodes formed in the nozzles, and grounded to prevent electric field interference between the nozzles, wherein the third electrode may be formed on a top surface of the first nozzle layer or a top surface of the second nozzle layer.

Here, a groove may be recessed downwards on a top surface of the first nozzle layer or a top surface of the second nozzle layer, and the third electrode may be formed inside the groove.

Here, the third electrode may be formed on a bottom surface of the first nozzle layer or second nozzle layer.

Here, a bottom of the first nozzle layer or second nozzle layer may protrude downward to form a protruding portion for each nozzle, and the third electrode may be formed on a recessed portion between the protruding portions.

Here, a groove may be recessed upwards on a bottom surface of the first nozzle layer or second nozzle layer, and the third electrode is formed inside the groove.

Here, the printhead unit may further include a spacing layer disposed on the second nozzle layer and formed with a channel penetrated to communicate with the second chamber, wherein the third electrode is formed on a top surface of the spacing layer.

Here, a groove may be recessed downwards on the top surface of the spacing layer, and the third electrode may be formed inside the groove.

Here, the inkjet printhead may further include a blocking unit formed of an insulator and covering the groove to prevent the third electrode from being exposed to the outside of the groove.

Here, the controller may include: ground wiring connecting the first electrode to ground; and a switch formed in the ground wiring and selectively releasing the ground of the first electrode to generate an induced voltage in the first electrode.

In accordance with an embodiment of the disclosure, there is provided an inkjet printhead with a plurality of nozzles to eject a liquid solution by an electrohydrodynamic method, the inkjet printhead including: a printhead unit comprising a plurality of nozzles; a plurality of first electrodes formed inside the nozzle for each of the plurality of nozzles; a voltage controller configured to apply a constant voltage to ink inside the printhead unit; and a controller configured to control the first electrode to be grounded or be electrically disconnected from the ground, for each of the plurality of nozzles, wherein the controller controls each nozzle individually to eject the liquid solution in such a manner that the liquid solution is not ejected upon the first electrode being grounded but ejected upon the first electrode being electrically disconnected from the ground.

As described above, an inkjet printhead with a plurality of nozzles to eject a liquid solution by an electrohydrodynamic method according to the disclosure has an advantage of easily controlling the ejection of the liquid solution for each individual nozzle.

Further, there is an advantage of minimizing the electric field interference between the neighboring nozzles while ejecting the droplets through the multiple nozzles by the electrohydrodynamic method, thereby ejecting the droplets uniformly with easy control.

The present summary is provided only by way of example and not limitation. Other aspects of the present invention will be appreciated in view of the entirety of the present disclosure, including the entire text, claims, and accompanying figures.

### BRIEF DESCRIPTION OF DRAWINGS

FIG. 1 is a view showing a schematic structure of an inkjet printhead according to a first embodiment of the disclosure.

FIG. 2 is a view showing a schematic structure of an inkjet printhead as an alternative example of FIG. 1.

FIGS. 3 to 5 are views showing schematic structures of an inkjet printhead as another alternative example in connection with a third electrode.

FIG. 6 is a view showing a schematic structure of an inkjet printhead according to a second embodiment of the disclosure.

FIG. 7 is a view showing a schematic structure of an inkjet printhead according to a third embodiment of the disclosure.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF ILLUSTRATIVE EMBODIMENTS

Specific features of embodiments are involved in the detailed description and the accompanying drawings.

The merits and features of the disclosure, and methods of achieving them will become apparent with reference to the embodiments described below in detail and the accompanying drawings. However, the disclosure is not limited to the embodiments set forth herein, but may be implemented in various forms. The following embodiments are provided in order to fully describe the disclosure and enable those skilled in the art, to which the disclosure pertains, to understand the disclosure, the scope of which is defined in the appended claims. Like numerals refer to like elements throughout.

Below, an inkjet printhead according to embodiments of the disclosure will be described with reference to the accompanying drawings.

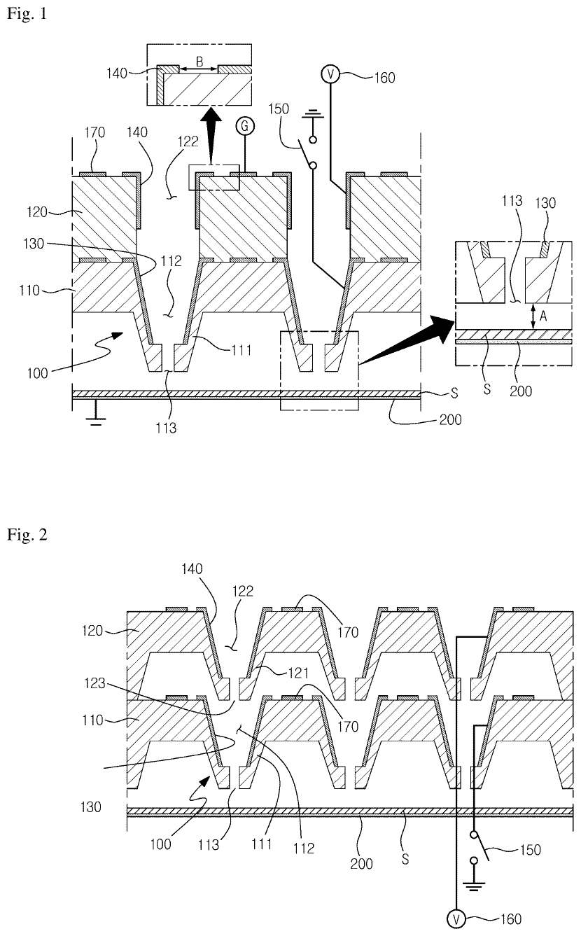

FIG. 1 is a view showing a schematic structure of an inkjet printhead according to a first embodiment of the disclosure.

An inkjet printhead according to an embodiment of the disclosure includes a plurality of nozzles 100, and each nozzle 100 ejects a liquid solution based on electrostatic force by an electrohydrodynamic method. In the accompanying drawings, two nozzles 100 are shown on the left and right in a horizontal direction, but this is for illustrative purposes only. Thus, a large number of nozzles 100 may be provided in the inkjet printhead. Further, the plurality of nozzles 100 may be provided in the form of a matrix as arranged in the front and back directions of the drawings.

The inkjet printhead according to an embodiment of the disclosure may include a printhead unit, a first electrode 130, a second electrode 140, a voltage controller 160, and a controller.

The printhead unit forms the outer appearance of the inkjet printhead. The printhead unit is formed with a plurality of nozzles 100. Further, the printhead unit may be formed with a chamber to store ink supplied from the outside.

In this embodiment, the printhead unit may be formed including a first nozzle layer 110 and a second nozzle layer 120. Further, the printhead unit may further include a spacing layer 180. In the first nozzle layer 110, a plurality of first chambers 112, in which ink supplied from the outside is stored, are spaced from each other, and a nozzle hole 113, through which a liquid solution is ejected, is formed at the bottom of the first chamber 112. Each nozzle 100 discharges the solution supplied to the first chamber 112 to the outside through the nozzle hole 113. In this case, as shown, the first chamber 112 may be, shaped like, but not limited to, a truncated cone with a slope on the inside thereof, and thus have a cross-section tapering toward the bottom. Alternatively, the first chamber 112 may be shaped like a cylinder.

Regarding each nozzle 100, the bottom of the first nozzle layer 110 may protrude to form a protruding portion 111, and the nozzle hole 113 may be formed at the bottom of the protruding portion 111.

A first electrode 130 is placed for each of the plurality of nozzles 100, and may be grounded or electrically disconnected under control of the controller. As shown, the first electrode 130 may be formed on an inner surface of the first chamber 112. The first electrode 130 in the accompanying drawings is formed throughout the inner surface of the first chamber 112, but may be formed partially. Further, the upper end of the first electrode 130 may be formed partially extending on the top surface of the first nozzle layer 110.

The first electrode 130 may be coated with an insulating layer (not shown). The first electrode 130 coated with the insulating layer may cause the liquid solution introduced into the first chamber 112 to be induced and charged when an induced voltage is generated in the first electrode 130 (to be described later), and the charged liquid solution can be ejected to the outside through the nozzle hole 113 by the force of an electric field formed by the first electrode 130 and the second electrode 140.

For each of the plurality of nozzles 100, the controller may control the first electrode 130 to be grounded, or electrically disconnected from the ground. The controller may include ground wiring for connecting the first electrode 130 to the ground, and a switch 150 formed on the ground wiring. Therefore, when the switch 150 is turned on, the first electrode 130 may be grounded. When the switch 150 is turned off, the first electrode 130 may be electrically disconnected from the ground. When the first electrode 130 is not electrically connected to the ground, the first electrode 130 may generate a voltage induced by the second electrode 140 to which high voltage is applied. For reference, the drawings show the controller with respect to only one nozzle 100, but the controller is actually provided for each nozzle 100.

In this case, the controller may control the plurality of first electrodes 130, which are respectively formed in the plurality of nozzles 100 and spaced apart from each other, to be connected to or disconnected from the ground individually for the respective nozzles 100, rather than controlling the plurality of first electrodes 130 to be connected to or disconnected from the ground in common. As will be described later, the nozzle 100 of which the first electrode 130 is grounded does not eject the liquid solution. In the nozzle 100 of which the first electrode 130 is not electrically connected, an induced voltage from the second electrode 140, to which a constant voltage is applied, is generated in the first electrode 130. In this case, the liquid solution may be ejected by the force of an electric field formed based on the voltage induced in the first electrode 130 and the voltage applied to the second electrode 140. In this way, the switch 150 may be turned on/off to control the multiple nozzles 100 to eject the liquid solution for each nozzle 100.

The second nozzle layer 120 is formed above the first nozzle layer 110. The second nozzle layer 120 is formed with a plurality of second chambers 122 spaced from each other. The second chamber 122 is formed for each nozzle 100, and communicates with the first chamber 112 of the first nozzle layer 110. Like the first chamber 112, the second chamber 122 forms a space in which ink supplied from the outside is stored for each nozzle 100. The second chamber 122 may be shaped like a cylinder extending from the top of the first chamber 112, but is not necessarily limited thereto.

The second electrode 140 is formed inside the printhead unit. The second electrode 140 may be disposed for each of the plurality of nozzles 100, and applied with a voltage to eject the liquid solution by the electrohydrodynamic method. As shown, the second electrode 140 may be formed on an inner surface of the second chamber 122. Like the first electrode 130, the second electrode 140 may be formed throughout the inner surface of the second chamber 122, but may be formed partially. Further, the upper end of the second electrode 140 may be formed partially extending on the top surface of the second nozzle layer 120.

Although not shown, the second electrode 140 may also be coated with an insulating layer like the first electrode 130.

A voltage controller 160 applies the voltage to the second electrode 140 in order to eject the liquid solution by the electrohydrodynamic method. In this case, a constant voltage may be applied to the second electrode 140 for the plurality of nozzles 100. For reference, the drawings show that the voltage controller 160 is connected to only one second electrode 140, but, in practice, the plurality of second electrodes 140 are all connected to the voltage controller 160 and receive a constant voltage.

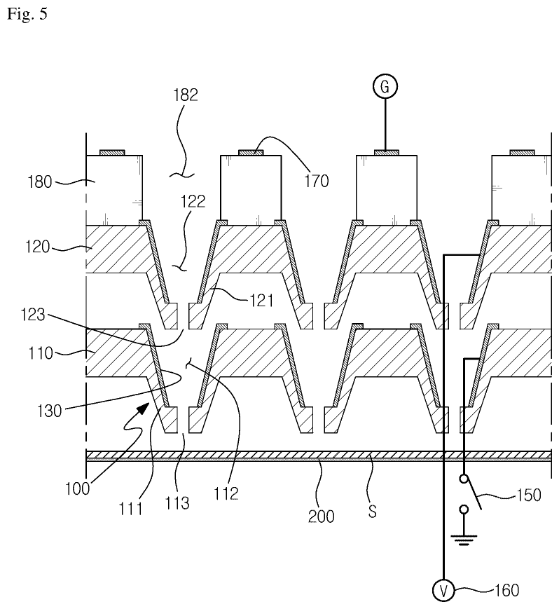

Further, as will be described later with reference to FIG. 6, the second electrode formed corresponding to each nozzle 100 may be formed as not an individual electrode but a common electrode. In other words, as shown in FIG. 1, the second electrodes 140 may not be spaced apart from each other corresponding to the nozzles 100, respectively, but may be connected to each other to form one common electrode. For example, the second electrode 140 may be formed on the second nozzle layer 120 as a single flat electrode.

Under a subject S to print on, a ground electrode 200, to which voltage having polarity opposite to those of the voltages applied to the first electrode 120 and the second electrode 140 is applied or a ground voltage is applied, may be formed. Further, the ground electrode 200 may not be electrically connected. The ground electrode 200 causes potential differences from the second electrode 140 to which a constant voltage is applied and the first electrode 120 in which the induced voltage is generated, so that the electric field for the ejection based on the electrohydrodynamic method can be more uniformly formed between the nozzle 100 and the subject S.

In this way, the first electrode 130 and the second electrode 140 are separated and disconnected from each other. The first electrode 130 may be controlled to be grounded or generate an induced voltage from the second electrode 140, under control of the controller. The second electrode 140 may be connected to the voltage controller 160 and receive a constant voltage.

Both the first electrode 130 and the second electrode 140 may refer to electrodes that form an electric field between the nozzle 100 and the subject S to eject the liquid solution by the electrohydrodynamic method.

In other words, the nozzle layers 110 and 120 according to the disclosure are stacked in a two-layered form, so that the liquid solution can be ejected to the outside through the nozzle hole 113 by the force of an electric field based on the voltage applied to the first electrode 130 and the second electrode 140.

According to the disclosure, the voltage controller 160 applies a constant voltage to the second electrode 140 formed on the second nozzle layer 120, and the switch 150 is controlled to be turned on and off to ground or electrically disconnect each first electrode 130 formed on the first nozzle layer 110. In this case, the switch 150 of each nozzle 100 may be controlled to individually control each nozzle 100 to eject the liquid solution or not to eject the liquid solution according to the electrical connection states of the first electrode 130. In other words, when the switch 150 is open to electrically disconnect the first electrode 130 in the state that a constant voltage is being applied to the second electrode 140, an induced voltage having a predetermined level is generated in the first electrode 130 by the second electrode 140 applied with a high voltage, and thus the liquid solution is ejected by an electrostatic force based on the voltage applied to the second electrode 140 and the induced voltage generated in the first electrode 130. On the other hand, when the switch 150 is closed to ground the first electrode 130 in the state that a constant voltage is being applied to the second electrode 140, 0V is applied to the first electrode 130 without generating an induced voltage, and thus only the voltage applied to the second electrode 140 is not enough to eject the liquid solution.

Therefore, among the plurality of nozzles 100, only the nozzles 100, of which the first electrode 130 is selectively grounded or disconnected from the ground to generate the induced voltage from the second electrode 140 by the controller, may selectively eject ink.

A third electrode 170 is formed between and spaced apart from the first electrodes 130 respectively formed in the nozzles 100, or is formed between and spaced apart from the second electrodes 140, and the third electrode 170 is grounded. By placing the grounded third electrode 170 between the nozzles 100, electric field interference between the neighboring nozzles 100 is minimized. For reference, the drawings show that only one third electrode 170 is grounded, but all the third electrodes 170 shown are actually grounded.

In this case, as shown in FIG. 1, the third electrode 170 according to this embodiment may be formed between the nozzles 100 on the top surface of the first nozzle layer 110 or the top surface of the second nozzle layer 120 at a position spaced apart from the first electrode 130 or the second electrode 140.

In this case, as shown in the enlarged views of FIG. 1, a distance B between the neighboring first and third electrodes 130 and 170 or a distance B between the neighboring second and third electrodes 140 and 170 may be greater than a distance A between the bottom of the nozzle 100 and the subject S. Thus, that each nozzle 100 can be individually controlled to eject the liquid solution with the minimum electric field interference between the neighboring nozzles 100. If the distance B is smaller than the distance A between the bottom of the nozzle 100 and the subject S, it is difficult to individually control each nozzle 100 to eject the liquid solution. Here, the distance B between the first electrode 130 and the third electrode 170 or the distance B between the second electrode 140 and the third electrode 170 may refer to the minimum distance between the ends of the two electrodes.

Because the distance B is fixed when the inkjet printhead is manufactured, the distance A between the bottom of the nozzle 100 and the subject S may be controlled within a range smaller than the distance B when the printing is performed using the inkjet printhead according to the disclosure.

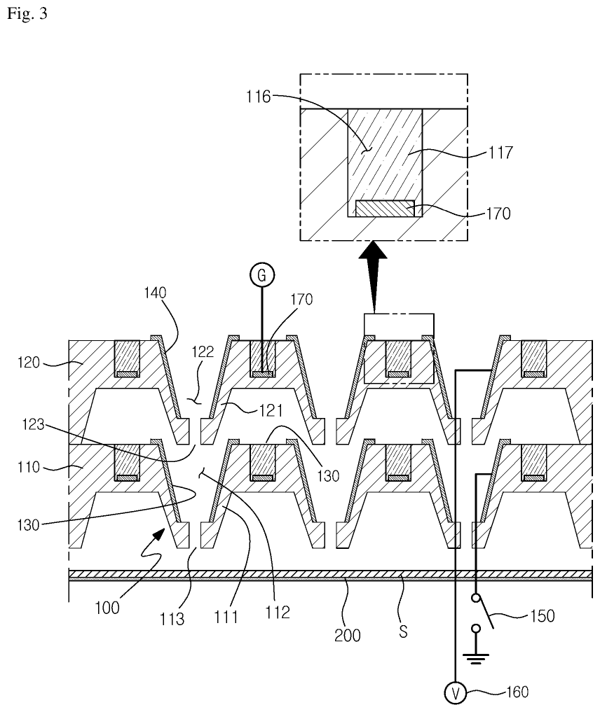

FIG. 2 is a view showing a schematic structure of an inkjet printhead as an alternative example of FIG. 1.

Below, descriptions will be made focusing on differences from the foregoing embodiment of FIG. 1

This embodiment is the same as the foregoing embodiment of FIG. 1 except the second nozzle layer 120.

In this embodiment, a nozzle hole 123 for ejecting the liquid solution may be formed at the lower end of the second chamber 122 of the second nozzle layer 120. In other words, the second nozzle layer 120 is formed with the nozzle hole 123 for ejecting fine droplets, and thus the second nozzle layer 120 may be formed to have the same shape as the first nozzle layer 110. The first chamber 112 of the first nozzle layer 110 and the second chamber 122 of the second nozzle layer 120 communicate with each other through the nozzle hole 123, but not smoothly connected unlike FIG. 1.

Even in this embodiment, the second electrode 140 formed in the second nozzle layer 120 is applied with a constant voltage from the voltage controller 160, and the first electrode 130 formed in the first nozzle layer 110 is individually controlled to be grounded or not to be electrically connected, thereby individually controlling each of the nozzles 100 to eject the liquid solution.

Further, the third electrode 170 may be formed to minimize the electric field interference between the neighboring nozzles 100 and control the ejection of the liquid solution through the individual nozzle 100 by the electrohydrodynamic method.

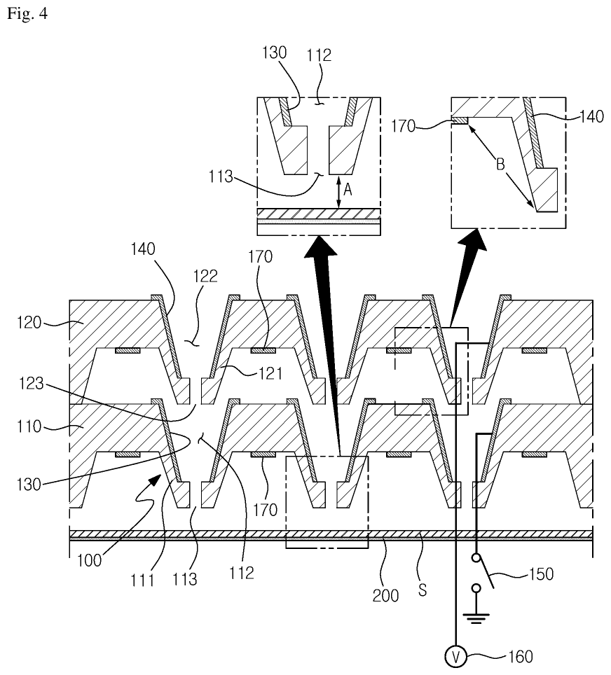

In the following description, alternative examples of the foregoing third electrode 170 will be described with reference to FIGS. 3 to 5.

FIGS. 3 to 5 are views showing schematic structures of an inkjet printhead as another alternative example in connection with the third electrode 170.

In the embodiment shown in FIGS. 3 to 5, the first nozzle layer 110, the first electrode 130, the second nozzle layer 120, and the second electrode 140 may have the same shapes, structures and electric control methods as those of the embodiments described above with reference to FIGS. 1 and 2.

First, as shown in FIG. 3, a groove 116 recessed downwards on the top surface of the first or second nozzle layer 110 or 120 may be formed between the nozzles 100. The groove 116 may be formed to have a length greater than a width, but is not necessarily limited thereto.

In this case, the grounded third electrode 170 may be formed inside the groove 116. Further, a blocking unit 117 may be additionally formed to cover the groove 116 and block the third electrode 170 from being exposed to the outside of the groove 116 after forming the third electrode 170 inside the groove 116. The blocking unit 117 may be formed of an insulator.

With this structure that the grounded third electrode 170 is formed inside the groove 116 covered with the insulator, the electric field interference between the neighboring nozzles 100 is minimized.

Next, as shown in FIG. 4, the third electrode 170 may be formed between the nozzles 100 on the bottom surface of the first nozzle layer 110 or the second nozzle layer 120. In this case, as described above, the third electrode 170 may be formed on a recessed portion between the protruding portions 111 and 121 because the protruding portions 111 and 121 formed with the nozzle holes 113 and 123 on the lower ends thereof are formed below the nozzle layers 110 and 120.

In this embodiment, a distance B between the bottom of the nozzle layer 110 and the third electrode 170 or a distance B between the bottom of the second nozzle layer 120 and the third electrode 170 may be greater than a distance A between the bottom of the nozzle 100 and the subject S. In this case, the electric field interference between the neighboring nozzles 100 is minimized, so that each nozzle 100 can be individually controlled to eject the liquid solution without wetting. On the other hand, if the distance B is smaller than the distance A between the bottom of the nozzle 100 and the subject S, it is difficult to individually control each nozzle 100 to eject the liquid solution due to the electric field interference between the neighboring nozzles 100, and wetting may occur.

Even in this embodiment, because the distance B is fixed when manufactured, the distance A between the bottom of the nozzle 100 and the subject S may be controlled within a range smaller than the distance B when the printing is performed using the inkjet printhead according to the disclosure.

Although not shown, a groove 116 recessed upwards on the bottom surface of each nozzle layer 110, 120 may be formed like that described above with reference to FIG. 3, and the third electrode 170 may be formed inside the groove 116. Likewise, the groove 116 may be covered with the insulator, i.e., the blocking unit 117, thereby preventing the third electrode 170 from being exposed to the outside.

Next, as shown in FIG. 5, a spacing layer 180 may be added onto the second nozzle layer 120. The spacing layer 180 is formed on the second nozzle layer 120, and formed with a channel 182 penetrated to communicate with the second chamber 122. The electrode is not formed inside the channel 182. The spacing layer 180 may be formed of a wafer made of an insulating material and having a predetermined thickness.

In this case, the grounded third electrode 170 may be formed on the top surface of the spacing layer 180. Similarly, the electric field interference between the neighboring nozzles 100 is prevented by the third electrode 170.

Compared to the foregoing embodiment, the spacing layer 180 keeps the distance B between the second electrode 140 and the third electrode 170 longer, and thus the distance A between the bottom of the nozzle 100 and the subject S can be kept longer than the foregoing embodiment, thereby performing the printing through individual control.

Although not shown, a groove 116 recessed downwards on the top surface of the spacing layer 180 may be formed like that described above with reference to FIG. 3, and the third electrode 170 may be formed inside the groove 116. Likewise, the groove 116 may be covered with the insulator, i.e., the blocking unit 117, thereby preventing the second electrode 140 from being exposed to the outside.

FIG. 6 is a view showing a schematic structure of an inkjet printhead according to a second embodiment of the disclosure.

In this embodiment, descriptions will be made below focusing on differences from the foregoing embodiments described with reference to FIGS. 1 to 5.

In the foregoing embodiments, the printhead unit is divisionally formed with the first nozzle layer 110 and the second nozzle layer 120, and each nozzle 100 includes the chamber formed based on the communication between the first chamber 112 and the second chamber 122. On the other hand, a printhead unit 310 in this embodiment includes a common chamber 312 formed as chambers 312 for a plurality of nozzles 100 are connected to each other.

Further, the second electrode 140 is not divisionally formed for each electrode but formed as a common electrode inside the chamber 312.

In this case, the first electrode 130 is formed for each nozzle 100, and the controller is individually formed for each first electrode 130. Likewise, even in this embodiment, only the nozzle 100 controlled to be electrically disconnected from the ground ejects the liquid solution by the force of an electric field based on an induced voltage additionally generated in the first electrode 130.

Between the plurality of nozzles 100, a third electrode (not shown) may be formed being grounded.

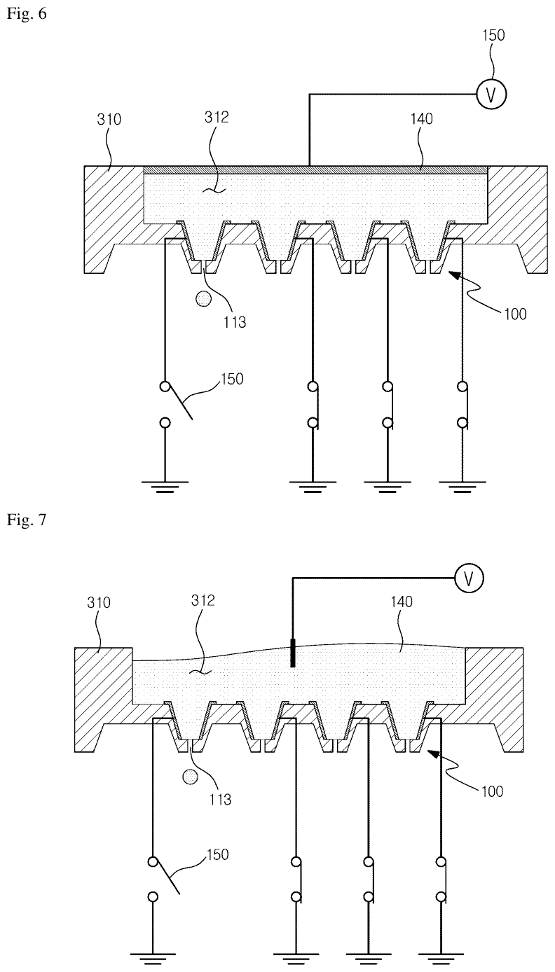

FIG. 7 is a view showing a schematic structure of an inkjet printhead according to a third embodiment of the disclosure.

Even in this embodiment, descriptions will be made below focusing on differences from the foregoing embodiments described with reference to FIGS. 1 to 6.

In this embodiment, the second electrode 140 is not formed, and the voltage controller 160 applying a constant voltage is directly connected to the solution inside the printhead unit 310 and charges the liquid solution.

Like the foregoing embodiments, the controller is individually formed for the first electrode 130 individually formed for each nozzle 100, and only the nozzle 100 controlled to be electrically disconnected from the ground ejects the liquid solution by the force of an electric field based on an additionally generated induced voltage.

Although detailed embodiments of a fluidic lens with a variable focal length according to the disclosure have been described, the disclosure is not limited to such detailed embodiments. Various changes and modifications can be made by a person having ordinary knowledge in the art without departing from the spirit and scope of the invention defined in the appended claims.

1. An inkjet printhead with a plurality of nozzles to eject a liquid solution by an electrohydrodynamic method, the inkjet printhead comprising:
a printhead unit comprising a plurality of nozzles;
a plurality of first electrodes formed inside the nozzle for each of the plurality of nozzles;
a second electrode formed inside the printhead unit and receiving a voltage for ejecting the liquid solution by the electrohydrodynamic method;
a voltage controller configured to apply a constant voltage to the second electrode; and
a controller configured to control the first electrode to be grounded or be electrically disconnected from the ground, for each of the plurality of nozzles,
wherein the controller controls each nozzle individually to eject the liquid solution in such a manner that the liquid solution is not ejected upon the first electrode being grounded but ejected by generating an induced voltage in the first electrode upon the first electrode being electrically disconnected from the ground.

2. The inkjet printhead of claim 1, wherein the second electrode is formed as a common electrode for the plurality of nozzles.

3. The inkjet printhead of claim 1, wherein the printhead unit comprises:
a first nozzle layer comprises the plurality of nozzles, and a first chamber formed to store ink supplied for each of the plurality of nozzles; and
a second nozzle layer formed above the first nozzle layer, comprising a second chamber communicating with the first chamber for each of the plurality of nozzles, and forming the second electrode.

4. The inkjet printhead of claim 3, wherein the second chamber comprises a nozzle hole at a bottom thereof to eject the liquid solution.

5. The inkjet printhead of claim 3, wherein the first electrode is formed on an inner surface of the first chamber, and the second electrode is formed on an inner surface of the second chamber.

6. The inkjet printhead of claim 1, further comprising a third electrode disposed between and spaced apart from the first electrodes formed in the nozzles, or disposed between and spaced apart from the second electrodes formed in the nozzles, and grounded to prevent electric field interference between the nozzles.

7. The inkjet printhead of claim 3, further comprising a third electrode disposed between and spaced apart from the first electrodes formed in the nozzles, or disposed between and spaced apart from the second electrodes formed in the nozzles, and grounded to prevent electric field interference between the nozzles,
wherein the third electrode is formed on a top surface of the first nozzle layer or a top surface of the second nozzle layer.

8. The inkjet printhead of claim 7, wherein a groove is recessed downwards on a top surface of the first nozzle layer or a top surface of the second nozzle layer, and the third electrode is formed inside the groove.

9. The inkjet printhead of claim 7, wherein the third electrode is formed on a bottom surface of the first nozzle layer or second nozzle layer.

10. The inkjet printhead of claim 9, wherein a bottom of the first nozzle layer or second nozzle layer protrudes downward to form a protruding portion for each nozzle, and the third electrode is formed on a recessed portion between the protruding portions.

11. The inkjet printhead of claim 9, wherein a groove is recessed upwards on a bottom surface of the first nozzle layer or second nozzle layer, and the third electrode is formed inside the groove.

12. The inkjet printhead of claim 7, wherein
the printhead unit further comprises a spacing layer disposed on the second nozzle layer and formed with a channel penetrated to communicate with the second chamber, and
the third electrode is formed on a top surface of the spacing layer.

13. The inkjet printhead of claim 12, wherein a groove is recessed downwards on the top surface of the spacing layer, and the third electrode is formed inside the groove.

14. The inkjet printhead of claim 8, further comprising a blocking unit formed of an insulator and covering the groove to prevent the third electrode from being exposed to an outside of the groove.

15. The inkjet printhead of claim 1, wherein the controller comprises:
ground wiring connecting the first electrode to ground; and
a switch formed in the ground wiring and selectively releasing the ground of the first electrode to generate an induced voltage in the first electrode.

16. An inkjet printhead with a plurality of nozzles to eject a liquid solution by an electrohydrodynamic method, the inkjet printhead comprising:
a printhead unit comprising a plurality of nozzles;
a plurality of first electrodes formed inside the nozzle for each of the plurality of nozzles;
a voltage controller configured to apply a constant voltage to ink inside the printhead unit; and
a controller configured to control the first electrode to be grounded or be electrically disconnected from the ground, for each of the plurality of nozzles,
wherein the controller controls each nozzle individually to eject the liquid solution in such a manner that the liquid solution is not ejected upon the first electrode being grounded but ejected upon the first electrode being electrically disconnected from the ground.

17. The inkjet printhead of claim 11, further comprising a blocking unit formed of an insulator and covering the groove to prevent the third electrode from being exposed to the outside of the groove.

18. The inkjet printhead of claim 13, further comprising a blocking unit formed of an insulator and covering the groove to prevent the third electrode from being exposed to the outside of the groove.
